(19) United States
(12) Patent Application Publication
(10) Pub. No.: US 2014/0364061 A1
(43) Pub. Date: Dec. 11, 2014

(54) WIRELESS TRANSMISSION APPARATUS WITH BLUETOOTH AND SHORT DISTANCE COMMUNICATION

(71) Applicant: Jogtek Corp., Taipei City (TW)

(72) Inventors: Wei-Chun HUANG, Taipei City (TW); Tsung-Hsing HSIEH, Taipei City (TW)

(21) Appl. No.: 13/915,041

(22) Filed: Jun. 11, 2013

(51) Int. Cl. H04W 4/00

(52) U.S. Cl. CPC H04W 4/008
USPC 455/41.2

(57) ABSTRACT

A wireless transmission apparatus with Bluetooth and short distance communication includes a processing unit, a Bluetooth communication side interface unit, a Bluetooth communication unit, a short distance communication side interface unit, and a short distance communication unit. The processing unit is configured to control the Bluetooth communication unit through the Bluetooth communication side interface unit to transmit information in the Bluetooth communication unit to the processing unit and the short distance communication unit. The processing unit is configured to control the short distance communication unit through the short distance communication side interface unit to transmit information in the short distance communication unit to the processing unit and the Bluetooth communication unit.

### BACKGROUND OF THE INVENTION

1. Field of the Invention

The present invention relates to a wireless transmission apparatus, and especially relates to a wireless transmission apparatus with Bluetooth and short distance communication.

2. Description of the Related Art

Bluetooth uses a radio technology called frequency-hopping spread spectrum. Bluetooth provides a secure way to connect and exchange information between wireless transmission devices.

Radio frequency identification (RFID) is a technology for retrieving data from radio frequency identification tags. Radio frequency identification tags can be read on a short distance from a radio frequency identification reader.

Near field communication (NFC) is a high frequency wireless communication method applied in wireless transmission devices that are spaced from each other within about a distance of 10 cm. The near field communication technology is an extension of the radio frequency identification technology.

Bluetooth, radio frequency identification, and near field communication are common wireless communication technologies. Bluetooth, radio frequency identification, and near field communication are applied to different areas and wireless transmission devices because the technologies of Bluetooth, radio frequency identification, and near field communication are not complete the same. There is no any wireless transmission device that combines Bluetooth, radio frequency identification, and near field communication perfectly and completely.

### SUMMARY OF THE INVENTION

In order to solve the above-mentioned problems, an object of the present invention is to provide a wireless transmission apparatus with Bluetooth and short distance communication.

In order to achieve the object of the present invention mentioned above, the wireless transmission apparatus with Bluetooth and short distance communication of the present invention includes a processing unit, a Bluetooth communication side interface, unit, a Bluetooth communication unit, a short distance communication side interface unit, and a short distance communication unit. The Bluetooth communication side interface unit is electrically connected to the processing unit. The Bluetooth communication unit is electrically connected to the Bluetooth communication side interface unit. The short distance communication side interface unit is electrically connected to the processing unit. The short distance communication unit is electrically connected to the short distance communication side interface unit. The short distance communication unit includes a short distance communication side processing subunit, a dual interface memory subunit, a short distance communication side matching circuit subunit, and a short distance communication side antenna subunit. The short distance communication side processing subunit is electrically connected to the short distance communication side interface unit. The dual interface memory subunit is electrically connected to the short distance communication side processing subunit. The short distance communication side matching circuit subunit is electrically connected to the dual interface memory subunit. The short distance communication side antenna subunit is electrically connected to the short distance communication side matching circuit subunit. The dual interface memory subunit includes a communication bus interface component, a memory component, a radio frequency interface component, a current-to-voltage converting component, and a voltage regulation component. The communication bus interface component is electrically connected to the short distance communication side processing subunit. The memory component is electrically connected to the communication bus interface component. The radio frequency interface component is electrically connected to the memory component and the short distance communication side matching circuit subunit. The current-to-voltage converting component is electrically connected to the radio frequency interface component. The voltage regulation component is electrically connected to the current-to-voltage converting component and the short distance communication side processing subunit. The processing unit is configured to control the Bluetooth communication unit through the Bluetooth communication side interface unit to transmit information in the Bluetooth communication unit to the processing unit and the short distance communication unit. The processing unit is configured to control the short distance communication unit through the short distance communication side interface unit to transmit information in the short distance communication unit to the processing unit and the Bluetooth communication unit.

### BRIEF DESCRIPTION OF DRAWING

FIG. 1 shows a block diagram of the wireless transmission apparatus with Bluetooth and short distance communication of the present invention.

FIG. 2 shows a block diagram of the short distance communication unit of the present invention.

FIG. 3 shows a block diagram of the Bluetooth communication unit of the present invention.

### DETAILED DESCRIPTION OF THE INVENTION

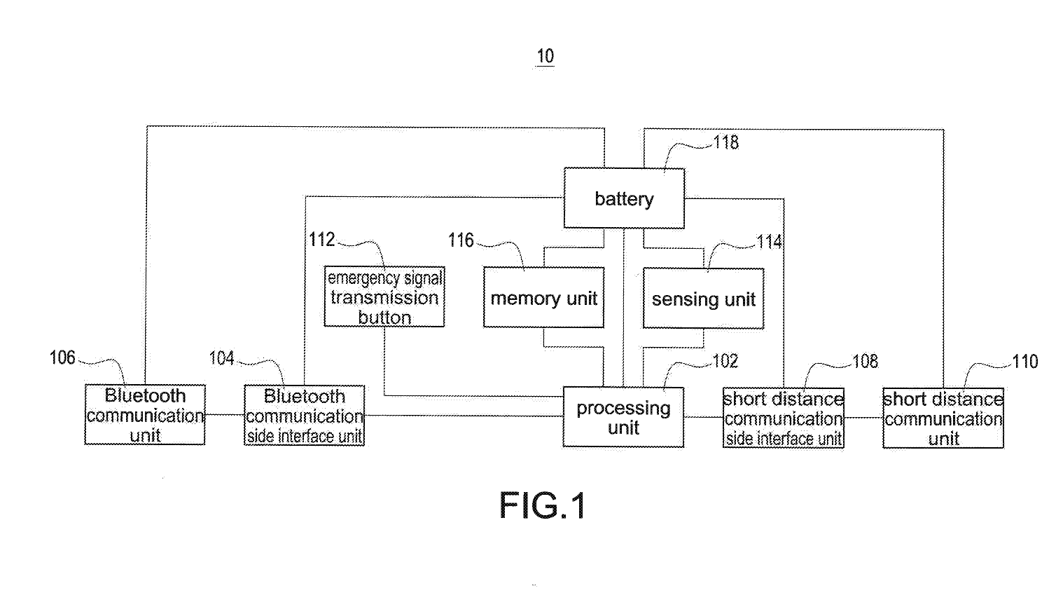

FIG. 1 shows a block diagram of the wireless transmission apparatus with Bluetooth and short distance communication of the present invention. A wireless transmission apparatus 10 with Bluetooth and short distance communication includes a processing unit 102, a Bluetooth communication side interface unit 104, a Bluetooth communication unit 106, a short distance communication side interface unit 108, a short distance communication unit 110, an emergency signal transmission button 112, a sensing unit 114, a memory unit 116, and a battery 118.

The processing unit 102 is electrically connected to the Bluetooth communication side interface unit 104, the short distance communication side interface unit 108, the emergency signal transmission button 112, the sensing unit 114, and the memory unit 116. The battery 118 is electrically connected to the processing unit 102, the Bluetooth communication side interface unit 104, the Bluetooth communication unit 106, the short distance communication side interface unit 108, the short distance communication unit 110, the sensing unit 114, and the memory unit 116. The Bluetooth communication side interface unit 104 is electrically connected to the Bluetooth communication unit 106. The short distance communication side interface unit 108 is electrically connected to the short distance communication unit 110.

In an embodiment, the wireless transmission apparatus 10 with Bluetooth and short distance communication is made in bracelet-shaped. Therefore, the wireless transmission apparatus 10 with Bluetooth and short distance communication is worn on a user's wrist.

The emergency signal transmission button 112 informs the processing unit 102 when the emergency signal transmission button 112 is pressed by the user. The processing unit 102 is configured to control the Bluetooth communication unit 106 through the Bluetooth communication side interface unit 104 to send out a wireless emergency signal (not shown in FIG. 1). Therefore, an administrator in the far-end will know that the user needs help.

The sensing unit 114 is a temperature sensor or a heartbeat sensor. The sensing unit 114 is used to sense the user's temperature or heartbeat. Then, the sensing unit 114 informs the processing unit 102. The processing unit 102 is configured to control the Bluetooth communication unit 106 through the Bluetooth communication side interface unit 104 to send out the wireless emergency signal. Therefore, the administrator in the far-end will know that the user needs help.

The Bluetooth communication side interface unit 104 is a universal asynchronous receiver/transmitter (UART), a serial peripheral interface (SPI), or an inter integrated circuit bus (PC bus). The Bluetooth communication unit 106 is a Bluetooth module with low power consumption.

The short distance communication side interface unit 108 is a serial peripheral interface or an inter integrated circuit bus. The short distance communication unit 110 is a radio frequency identification (RFID) module or a near field communication (NFC) module.

The battery 118 is used to supply power to the processing unit 102, the Bluetooth communication side interface unit 104, the Bluetooth communication unit 106, the short distance communication side interface unit 108, the short distance communication unit 110, the sensing unit 114, and the memory unit 116. Moreover, the short distance communication unit 110 can transfer the energy of a short distance wireless signal (not shown in FIG. 1) into power for driving the short distance communication unit 110. Therefore, the battery 118 may not supply power to the short distance communication unit 110 (will be described in details afterward).

The memory unit 116 is an electrically erasable programmable read only memory (EEPROM), a ferroelectric nonvolatile random access memory (FRAM), or a flash memory. The memory unit 116 is used to memorize the information in the Bluetooth communication unit 106 and the short distance communication unit 110 (for example, NDEF).

The processing unit 102 is a microprocessor or a microcontroller. The processing unit 102 is configured to control the Bluetooth communication unit 106 through the Bluetooth communication side interface unit 104 to transmit information in the Bluetooth communication unit 106 to the processing unit 102 and the short distance communication unit 110. The processing unit 102 is configured to control the short distance communication unit 110 through the short distance communication side interface unit 108 to transmit information in the short distance communication unit 110 to the processing unit 102 and the Bluetooth communication unit 106.

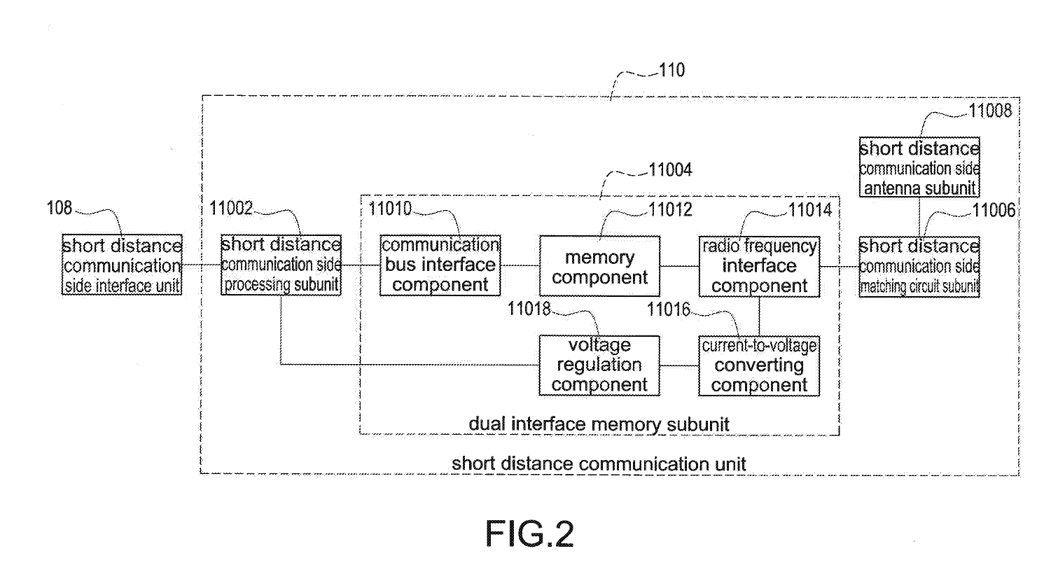

FIG. 2 shows a block diagram of the short distance communication unit of the present invention. The short distance communication unit 110 includes a short distance communication side processing subunit 11002, a dual interface memory subunit 11004, a short distance communication side matching circuit subunit 11006, and a short distance communication side antenna subunit 11008.

The dual interface memory subunit 11004 includes a communication bus interface component 11010, a memory component 11012, a radio frequency interface component 11014, a current-to-voltage converting component 11016, and a voltage regulation component 11018.

The short distance communication side processing subunit 11002 is electrically connected to the short distance communication side interface unit 108, the communication bus interface component 11010, and the voltage regulation component 11018. The memory component 11012 is electrically connected to the communication bus interface component 11010 and the radio frequency interface component 11014. The current-to-voltage converting component 11016 is electrically connected to the radio frequency interface component 11014 and the voltage regulation component 11018. The short distance communication side matching circuit subunit 11006 is electrically connected to the short distance communication side antenna subunit 11008 and the radio frequency interface component 11014.

The short distance communication side antenna subunit 11008 receives the short distance wireless signal. The short distance communication side antenna subunit 11008 induces the short distance wireless signal into an induced current (not shown in FIG. 2). The induced current has the information of the short distance wireless signal.

The short distance communication side antenna subunit 11008 sends the induced current to the short distance communication side matching circuit subunit 11006. The short distance communication side matching circuit subunit 11006 sends the induced current to the radio frequency interface component 11014.

The radio frequency interface component 11014 sends the induced current to the memo component 11012 for memorizing the information of the short distance wireless signal. The radio frequency interface component 11014 sends the induced current to the current-to-voltage converting component 11016 for converting the induced current into an induced voltage (not shown in FIG. 2).

The current-to-voltage converting component 11016 sends the induced voltage to the voltage regulation component 11018 for regulating the induced voltage into a driving voltage. The voltage regulation component 11018 sends the driving voltage to the short distance communication side processing subunit 11002. The short distance communication side processing subunit 11002 is driven by the driving voltage. The short distance communication side processing subunit 11002 fetches the information of the short distance wireless signal memorized in the memory component 11012 through the communication bus interface component 11010.

Therefore, the short distance communication unit 110 can transfer the energy of the short distance wireless signal into power for driving the short distance communication unit 110. The battery 118 may not supply power to the short distance communication unit 110.

The short distance communication side processing subunit 11002 is a microprocessor or a microcontroller. The dual interface memory subunit 11004 is a dual interface electrically erasable programmable read only memory. The frequency of the short distance communication side antenna subunit 11008 is 13.56 MHz. The communication bus interface component 11010 is an inter integrated circuit bus.

The memory component 11012 is an electrically erasable programmable read only memory. The radio frequency interface component 11014 is a radio frequency identification interface or a near field communication interface.

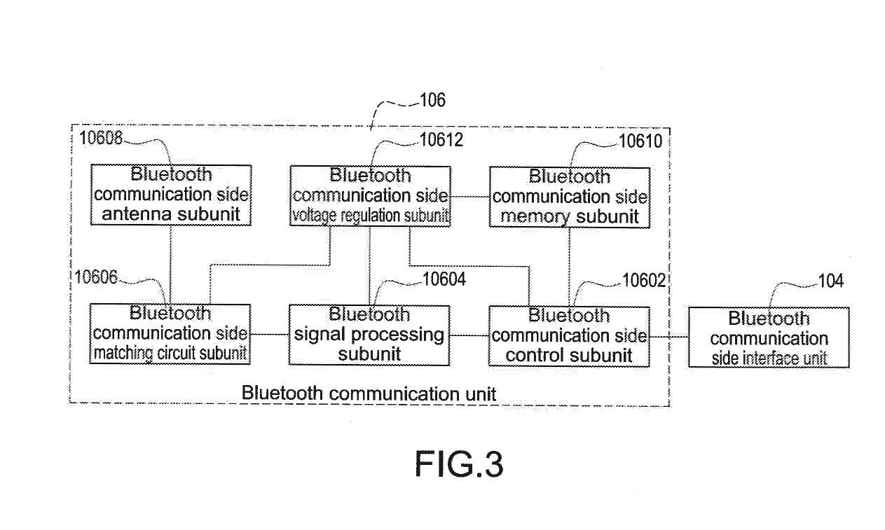

FIG. 3 shows a block diagram of the Bluetooth communication unit of the present invention. The Bluetooth communication unit 106 includes a Bluetooth communication side control subunit 10602, a Bluetooth signal processing subunit 10604, a Bluetooth communication side matching circuit subunit 10606, a Bluetooth communication side antenna subunit 10608, a Bluetooth communication side memory subunit 10610, and a Bluetooth communication side voltage regulation subunit 10612.

The Bluetooth communication side control subunit 10602 is electrically connected to the Bluetooth communication side interface unit 104, the Bluetooth signal processing subunit 10604, the Bluetooth communication side memory subunit 10610, and the Bluetooth communication side voltage regulation subunit 10612. The Bluetooth communication side voltage regulation subunit 10612 is electrically connected to the Bluetooth communication side memory subunit 10610, the Bluetooth signal processing subunit 10604, and the Bluetooth communication side matching circuit subunit 10606. The Bluetooth communication side matching circuit subunit 10606 is electrically connected to the Bluetooth signal processing subunit 10604 and the Bluetooth communication side antenna subunit 10608.

In an embodiment, according to the Bluetooth communication unit 106 and the triangle locating method, the present invention is applied to the location-based service (LBS) and the real time locating system (RTLS).

The Bluetooth communication side control subunit 10602 is a microprocessor or a microcontroller. The frequency of the Bluetooth communication side antenna subunit 10608 is 2.4 GHz. The Bluetooth communication side memory subunit 10610 is a random access memory (RAM).

Moreover, the wireless transmission apparatus 10 with Bluetooth and short distance communication further includes a display unit. The display unit is electrically connected to the processing unit 102. The display unit is, for example, an electronic paper or a liquid crystal display. The wireless transmission apparatus 10 with Bluetooth and short distance communication can be applied to the electronic shelf label (ESL).

The present invention includes following features.

1. The processing unit 102 is configured to control the Bluetooth communication unit 106 through the Bluetooth communication side interface unit 104 to transmit information in the Bluetooth communication unit 106 to the processing unit 102 and the short distance communication unit 110.

2. The processing unit 102 is configured to control the short distance communication unit 110 through the short distance communication side interface unit 108 to transmit information in the short distance communication unit 110 to the processing unit 102 and the Bluetooth communication unit 106.

3. The short distance communication unit 110 can transfer the energy of the short distance wireless signal into power for driving the short distance communication unit 110. Therefore, the battery 118 may not supply power to the short distance communication unit 110.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wireless transmission apparatus with Bluetooth and short distance communication including:
a processing unit;
a Bluetooth communication side interface unit electrically connected to the processing unit;
a Bluetooth communication unit electrically connected to the Bluetooth communication side interface unit;
a short distance communication side interface unit electrically connected to the processing unit; and
a short distance communication unit electrically connected to the short distance communication side interface unit,
wherein the short distance communication unit includes:
a short distance communication side processing subunit electrically connected to the short distance communication side interface unit;
a dual interface memory subunit electrically connected to the short distance communication side processing subunit;
a short distance communication side matching circuit subunit electrically connected to the dual interface memory subunit; and
a short distance communication side antenna subunit electrically connected to the short distance communication side matching circuit subunit,
wherein the dual interface memory subunit includes:
a communication bus interface component electrically connected to the short distance communication side processing subunit;
a memory component electrically connected to the communication bus interface component;
a radio frequency interface component electrically connected to the memory component and the short distance communication side matching circuit subunit;
a current-to-voltage converting component electrically connected to the radio frequency interface component; and
a voltage regulation component electrically connected to the current-to-voltage converting component and the short distance communication side processing subunit,
wherein the processing unit is configured to control the Bluetooth communication unit through the Bluetooth communication side interface unit to transmit information in the Bluetooth communication unit to the processing unit and the short distance communication unit; the processing unit is configured to control the short distance communication unit through the short distance communication side interface unit to transmit information in the short distance communication unit to the processing unit and the Bluetooth communication unit.

2. The wireless transmission apparatus with Bluetooth and short distance communication in claim 1, wherein the Bluetooth communication unit includes:
a Bluetooth communication side control subunit electrically connected to the Bluetooth communication side interface unit;
a Bluetooth signal processing subunit electrically connected to the Bluetooth communication side control subunit;
a Bluetooth communication side matching circuit subunit electrically connected to the Bluetooth signal processing subunit;
a Bluetooth communication side antenna subunit electrically connected to the Bluetooth communication side matching circuit subunit;
a Bluetooth communication side memory subunit electrically connected to the Bluetooth communication side control subunit; and
a Bluetooth communication side voltage regulation subunit electrically connected to the Bluetooth communication side control subunit, the Bluetooth signal processing subunit, the Bluetooth communication side matching circuit subunit, and the Bluetooth communication side memory subunit.

3. The wireless transmission apparatus with Bluetooth and short distance communication in claim 2, further including an emergency signal transmission button electrically connected to the processing unit.

4. The wireless transmission apparatus with Bluetooth and short distance communication in claim 3, further including a sensing unit electrically connected to the processing unit.

5. The wireless transmission apparatus with Bluetooth and short distance communication in claim 4, further including a memory unit electrically connected to the processing unit.

6. The wireless transmission apparatus with Bluetooth and short distance communication in claim 5, further including a battery electrically connected to the processing unit, the Bluetooth communication side interface unit, the Bluetooth communication unit, the short distance communication side interface unit, the short distance communication unit, the sensing unit, and the memory unit.

7. The wireless transmission apparatus with Bluetooth and short distance communication in claim 6, wherein the sensing unit is a temperature sensor or a heartbeat sensor.

8. The wireless transmission apparatus with Bluetooth and short distance communication in claim 6, wherein the processing unit is a microprocessor or a microcontroller; the Bluetooth communication side interface unit is a universal asynchronous receiver/transmitter, a serial peripheral interface, or an inter integrated circuit bus; the Bluetooth communication unit is a Bluetooth module with low power consumption; the short distance communication side interface unit is a serial peripheral interface or an inter integrated circuit bus; the short distance communication unit is a radio frequency identification module or a near field communication module; the memory unit is an electrically erasable programmable read only memory, a ferroelectric nonvolatile random access memory, or a flash memory.

9. The wireless transmission apparatus with Bluetooth and short distance communication in claim 6, wherein the short distance communication side processing subunit is a microprocessor or a microcontroller; the dual interface memory subunit is a dual interface electrically erasable programmable read only memory; the frequency of the short distance communication side antenna subunit is 13.56 MHz; the communication bus interface component is an inter integrated circuit bus; the memory component is an electrically erasable programmable read only memory; the radio frequency interface component is a radio frequency identification interface or a near field communication interface.

10. The wireless transmission apparatus with Bluetooth and short distance communication in claim 6, wherein the Bluetooth communication side control subunit is a microprocessor or a microcontroller; the frequency of the Bluetooth communication side antenna subunit is 2.4 GHz; the Bluetooth communication side memory subunit is a random access memory.
